(19) United States
(12) Patent Application Publication
(10) Pub. No.: US 2012/0145313 A1
(43) Pub. Date: Jun. 14, 2012

(54) HEAT TRANSFERABLE PROTECTIVE FILM

(76) Inventors: Alessandro Canacci, Camisano Vicentino (IT); Ugo Pellegrini, Treviso (IT)

(21) Appl. No.: 13/309,167

(22) Filed: Dec. 1, 2011

(30) Foreign Application Priority Data
Dec. 1, 2010 (IT) VI2010A000326

(51) Int. Cl. B44C 1/17; C09J 7/02; C08L 33/08; B32B 37/06; B32B 38/14; B32B 7/12; B32B 5/00

(52) U.S. Cl. 156/230; 428/349; 428/340; 156/308.2; 156/277; 524/523

(57) ABSTRACT

A protective film, such as a heat transferable protective film, and a method of making the same, are disclosed. An exemplary protective film may be used to coat a label that has been printed and transferred to a garment. The protective film may include an acrylic polymer material, a vinyl copolymer material, a filler material, and an adhesion promoter. An exemplary method may include providing a heat transferable protective film material, and applying the heat transferable protective film material to a label after the label is secured to a garment. In one exemplary illustration, the film material includes an acrylic polymer material, a vinyl copolymer material, a filler material, and an adhesion promoter.

### CROSS-REFERENCE TO RELATED APPLICATIONS

This application claims the benefit of Italian Patent Application No. VI2010A000326, filed Dec. 1, 2010, which is hereby expressly incorporated by reference in its entirety.

### BACKGROUND

The present disclosure is generally directed to heat transferable protective films, e.g., intended for coating labels such as those obtained through digital printing, which may be previously printed and already transferred onto garments so as to embellish or personalize the item.

The technologies that are currently available for the textile market, e.g., to coat or otherwise protect labels applied to a garment, generally involve the use of products that are mainly liquid which stick to the material of a garment, thereby modifying its appearance and feel.

As examples, the following patent documents are specifically noted.

International Patent Publication No. WO A 93/13165 describes a conventional liquid application for the paper industry.

European Patent Publication No. EP A 0890673 concerns an application of a film using heat through industrial calendering, with the purpose of sticking onto printed fabrics.

U.S. Pat. No. 4,845,144 describes a conventional liquid application which deliberately sticks to the glass fibres for the field of the textile industry of sheets that are suitable for use in conveyor belts.

International Patent Publication No. WO A 01/34387 describes a conventional liquid application which deliberately sticks to fabrics or cloth.

European Patent Publication No. EP 0057813 also describes a conventional liquid application and it is intended for protecting work material made up of synthetic fibres.

U.S. Pat. No. 4,141,873 concerns a conventional liquid application intended for protecting different types of supports.

Finally, German Patent Publication No. DE 3444862 also describes a conventional liquid application carried out on covering fabrics to be used on flexible webs.

The use of liquid applications, e.g., as previously described and/or as disclosed in the above publications, results in a product that may stick directly to the fabrics upon application, thereby substantially modifying the appearance and the feel after being applied. Accordingly, there is a need for an improved protective film that does not or substantially resists adhering directly to a garment when the film is applied to a label secured to the garment.

### DETAILED DESCRIPTION

Reference in the specification to “one example,” “an example,” “one embodiment,” or “an embodiment” means that a particular feature, structure, or characteristic described in connection with the example is included in at least one example. The phrase “in one example” in various places in the specification does not necessarily refer to the same example each time it appears.

Various exemplary illustrations of a protective film, e.g., a heat transferable protective film, and methods of making the same, are disclosed herein. An exemplary protective film may be used to coat a label that has been printed and transferred to a garment. The protective film may include an acrylic polymer material, a vinyl copolymer material, a filler material, and an adhesion promoter.

An exemplary method may include providing a heat transferable protective film material, and applying the heat transferable protective film material to a label after the label is secured to a garment. In one exemplary illustration, the film material includes an acrylic polymer material, a vinyl copolymer material, a filler material, and an adhesion promoter.

The exemplary illustrations are generally directed to a film, which sticks to labels printed above the item exclusively and not to the fabric thereof, thus leaving the characteristics of the fabric or fibers thereof unaltered.

The film material may be transferred through hot pressing (e.g., using a professional press or iron), in contrast to wet deposition or calendaring as may be typical of some previous approaches. The film material may, in some exemplary approaches, be a generally dry material that is transferred to a label by application of heat, e.g., as applied by an iron or heating press, thereby forming a protective film overlying the label.

Moreover, the above-mentioned publications do not have anything in common with the exemplary films, for example in terms of the exemplary application methods, and in terms of the exemplary intended uses discussed herein. In particular, it should be remembered that the exemplary illustrations are in the form of a film and may be employed in conjunction with labels which are previously printed and/or transferred on to a garment. Moreover, the exemplary films may be capable of recognizing the fabric without sticking or adhering to the fabric, and attaching only onto the aforementioned label.

By contrast, the aforementioned documents, as mentioned above, generally concern a technical field that is different from that concerning the exemplary illustrations.

An exemplary protective film may be carried out through the following modalities or processes.

In one exemplary approach, a digital printing, such as a representation of a single subject, or a plurality of fragments that are unevenly distributed, may initially be transferred onto a garment with a manual or semiautomatic press. In one example, the following conditions may be employed to transfer the printing to the garment: 3″ to 175° C., with a pressure of 1-2 bar.

In this exemplary approach, a sheet of protective film, which has greater dimensions with respect to those of pressing, may then be pressed for 30″ at 175° C., with a pressure of 1-2 bar.

In this exemplary approach, after everything has cooled down a support of the protective film may be removed. The material may thereby be only transferred to the digital print and not also to the fabric.

Once the operation according to the above exemplary approach has finished, it is possible to see the exact application of the film on the label. More specifically, in contrast to a film at the fabric which stays attached to the paper support, an exemplary film at the label perfectly or completely separates from the support.

The exemplary approach and films discussed herein may be employed for making a protective film for coating a material intended for digital printing. In one exemplary illustration, an exemplary film may be suitable for being applied to the material after the material has been applied onto a garment.

In one advantageous aspect of an exemplary illustration, the application of the film is generally simple for workers, and does not require any particular expertise. Such a film may also be able to be used in any moment and over fibres of different kinds, for example textiles like cotton, as well as of the plastic type such as polyester, cotton-polyester mixes and nylon. Moreover, exemplary films may advantageously be applied without sticking in or adhering to the fabric of the textile item, while leaving the appearance and the feel unaltered.

All of the above advantages may be obtained by a film according to the exemplary illustrations. In one example, a protective film may be formed from or made up of a mixture made up of acrylic polymers, vinyl copolymers and filler that are already known for their anti-abrasive characteristics.

In one exemplary illustration, such a mixture has the following formula:
acrylic polymers 60%-70%
vinyl copolymers 20%-40%
filler 10%-20%

Advantageously, the basic weight or area density of this mixture may, in one exemplary illustration, range from 3 to 16 grams per square meter (g/m²).

Such a film may be arranged on a carrier (support) which can be of any nature (such as paper, or Polyethylene terephthalate (PET), or the like, merely as examples). In one exemplary illustration, the carrier or support is made of a heat resistant material, e.g., which resists temperatures up to 200° C. The carrier may be coupled to a polyolefin film and the overall basic weight or area density may have, in one exemplary illustration, a value of between 70 and 220 g/m².

In one exemplary illustration, the mixture can be deposited by any of the following processes:
1. depositing through spreading with the help of a blade, e.g., a doctor's blade;
2. spraying;
3. depositing through impression cylinders;
4. using a glazing machine: the material is deposited by gravity in the form of a very thin film of liquid mixture.
   Moreover, any other process that is convenient may be employed for depositing the mixture.

An exemplary film may be used over a digital print that has been previously transferred onto the garment. Exemplary films may advantageously attach to the digital material, without fixing itself to the underlying fabric, and may substantially follow an outer perimeter of the print itself In one exemplary illustration, a film may perfectly outline the perimeter of the print itself.

In one example, after the film is transferred, e.g., through a hot press above the digital material, the film may protect the digital print from abrasion phenomena and may also prevent loss of color from the digital material, e.g., from being washed in a washing machine. In some exemplary illustrations, a film may even resist abrasion and/or loss of color at wash temperatures of 92±3° C.

Exemplary films, e.g., as applied to cotton, polyester and nylon fabrics, have been tested and verified as resisting the above effects, i.e., abrasion or loss of color, on said fabrics. Also, wash resistance tests were carried out and obtained extremely positive results with respect to the exemplary films.

Washing tests were carried out with a washing machine set according to the following instructions:
a) UNI EN ISO 6330:2002.
b) Wascator 365 H machines. Front-loading, horizontal drum.
c) Washing process for machines with a drum with a horizontal axis-TIPO 1A^{h} (92±3)° C.
d) Drying process on a clothes line.
e) Type of washing powder: IEC (with optical whitener).
f) Ballast overall mass: 4.5 kg. Mass of the sample tubes: 0.5 Kg.
g) Ballast material used: textured polyester 100% with surface mass density of (312.5±20) g/m². The pieces are square-shaped and are (20±4) cm in size. Each test piece must weigh (50±5) g.

The rubbing fastness tests were carried out with a CROCKMETER according to standard ISO 105-X12.

Exemplary films may be transferred through hot pressing, such as with a professional press or a common iron, as compared with a wet calendering deposition process such as is disclosed in some of the above publications. For its versatility, exemplary films may be employed by smaller manufacturing companies, leaving wide space to the creativity of personalized prints which can also be protected at a later moment, e.g., after the print is secured to a garment.

The exemplary illustrations are not limited to the previously described examples. Rather, a plurality of variants and modifications are possible, which also make use of the ideas of the exemplary illustrations and therefore fall within the protective scope. Furthermore the exemplary illustrations also include other useful features, e.g., as described in the subject-matter of the dependent claims independently of the features of the other claims.

With regard to the processes, systems, methods, heuristics, etc. described herein, it should be understood that, although the steps of such processes, etc. have been described as occurring according to a certain ordered sequence, such processes could be practiced with the described steps performed in an order other than the order described herein. It further should be understood that certain steps could be performed simultaneously, that other steps could be added, or that certain steps described herein could be omitted. In other words, the descriptions of processes herein are provided for the purpose of illustrating certain embodiments, and should in no way be construed so as to limit the claimed invention.

Accordingly, it is to be understood that the above description is intended to be illustrative and not restrictive. Many embodiments and applications other than the examples provided would be evident upon reading the above description. The scope of the invention should be determined, not with reference to the above description, but should instead be determined with reference to the appended claims, along with the full scope of equivalents to which such claims are entitled. It is anticipated and intended that future developments will occur in the arts discussed herein, and that the disclosed systems and methods will be incorporated into such future embodiments. In sum, it should be understood that the invention is capable of modification and variation and is limited only by the following claims.

All terms used in the claims are intended to be given their broadest reasonable constructions and their ordinary meanings as understood by those skilled in the art unless an explicit indication to the contrary is made herein. In particular, use of the singular articles such as “a,” “the,” “the,” etc. should be read to recite one or more of the indicated elements unless a claim recites an explicit limitation to the contrary.

What is claimed is:

1. A protective film for coating a label, the label previously printed and transferred to a garment, the protective film comprising a heat transferable material, the heat transferable material comprising an acrylic polymer material, a vinyl copolymer material, a filler material, and an adhesion promoter.

2. The heat transferable protective film of claim 1, wherein the protective film comprises the following composition:
one or more acrylic polymer materials: 60%-70%;
one or more vinyl copolymer materials: 20%-30%;
one or more filler materials: 5%-10%; and
one or more adhesion promoters: 1%-5%.

3. The heat transferable protective film of claim 1, wherein the film has an area density between approximately 3 to 16 grams per square meter (g/m²).

4. The heat transferable protective film of claim 1, further comprising a carrier formed of a heat resistant material.

5. The heat transferable protective film of claim 4, wherein the heat resistant materials is configured to resist temperatures up to approximately 200° C.

6. The heat transferable protective film of claim 4, wherein the carrier is coupled to a polyolefin film.

7. The heat transferable protective film of claim 6, wherein an assembly consisting of the carrier and the polyolefin film has an area density between approximately 70 and 220 grams per square meter (g/m²).

7. The heat transferable protective film of claim 1, wherein the heat transferable protective film has been formed in a spreading process.

8. The heat transferable protective film of claim 1, wherein the heat transferable protective film has been formed in a spraying process.

9. The heat transferable protective film of claim 1, wherein the heat transferable protective film has been formed using impression cylinders.

10. The heat transferable protective film of claim 1, wherein the heat transferable protective film has been formed by a glazing machine.

11. The heat transferable protective film of claim 1, wherein the protective film is configured to resist adhering to the garment.

12. The heat transferable protective film of claim 1, wherein the protective film is formed from a dry material configured to transfer to the label upon application of heat.

13. A method, comprising:
providing a heat transferable protective film material, wherein the film material comprises an acrylic polymer material, a vinyl copolymer material, a filler material, and an adhesion promoter; and
applying the heat transferable protective film material to a label after the label is secured to a garment, thereby forming a protective film overlying the label.

14. The method of claim 13, wherein the protective film material comprises the following composition:
one or more acrylic polymer materials: 60%-70%;
one or more vinyl copolymer materials: 20%-30%;
one or more filler materials: 5%-10%; and
one or more adhesion promoters: 1%-5%.

15. The method of claim 13, further comprising providing a carrier formed of a heat resistant material, the carrier supporting the protective film material before the protective film material is applied to the label.

16. The method of claim 15, wherein the heat resistant material is configured to resist temperatures up to approximately 200° C.

17. The method of claim 13, wherein the protective film material is configured to resist adhering to at least one of a cotton and polyester material.

18. The method of claim 13, further comprising establishing the protective film material as a dry material, wherein applying the protective film material includes applying heat to the protective film material to form the protective film overlying the label.

19. The method of claim 13, further comprising forming the heat transferable protective film material in one of a spreading process, a spraying process, and with a glazing machine.

20. The method of claim 13, further comprising forming the label using a digital printing process.
